(19) United States
(12) Patent Application Publication
(10) Pub. No.: US 2021/0014059 A1
(43) Pub. Date: Jan. 14, 2021

(54) CONTROL METHOD, APPARATUS AND SYSTEM

(71) Applicant: SZ DJI TECHNOLOGY CO., LTD., Shenzhen (CN)

(72) Inventors: Yong YANG, Shenzhen (CN); Hanping CHEN, Shenzhen (CN)

(21) Appl. No.: 17/028,562

(22) Filed: Sep. 22, 2020

Related U.S. Application Data
(63) Continuation of application No. PCT/CN2018/080164, filed on Mar. 23, 2018.

(51) Int. Cl. H04L 9/32; H04L 9/08

(52) U.S. Cl. CPC H04L 9/321; H04L 9/0869

(57) ABSTRACT

A control method includes sending transformation information to a third-party load, receiving to-be-authenticated information sent by the third-party load and generated by the third-party load according to the transformation information and self-authentication information of the third-party load, and determining original authentication information of the third-party load according to the to-be-authenticated information and the transformation information.

### CROSS-REFERENCE TO RELATED APPLICATION

This application is a continuation of International Application No. PCT/CN2018/080164, filed on Mar. 23, 2018, the entire content of which is incorporated herein by reference.

### TECHNICAL FIELD

The present disclosure relates to the technical field of flight and, more particularly, to a control method, apparatus, and system.

### BACKGROUND

In order to improve an application scope of a flight platform, an open gimbal interface based on the flight platform is provided to third-party developers. The third-party developers develop third-party loads based on a software development kit (SDK) of the flight platform.

In the conventional technologies, the third-party loads developed by the third-party developers need to be authenticated before they can be used on the flight platform. Accordingly, before allowing a user to control any third-party load during a flight of the flight platform, it is necessary to verify whether the third-party load has been authenticated. For example, authentication information is obtained from the third-party load, and whether the obtained authentication information is the same as stored authentication information is determined based on the authentication information obtained from the third-party load. When they are the same, it can be considered that the third-party load has passed the authentication, otherwise, it is considered that the third-party load has failed the authentication.

However, since a communication protocol of the third-party load is an SDK communication protocol, other people are able to learn the communication protocol of the thirdparty load and obtain the authentication information of the third-party load based on the communication protocol, and hence, a security of the authentication information of the third-party load cannot be guaranteed .

### SUMMARY

In accordance with the disclosure, there is provided a control method including sending transformation information to a third-party load, receiving to-be-authenticated information sent by the third-party load and generated by the third-party load according to the transformation information and self-authentication information of the third-party load, and determining original authentication information of the third-party load according to the to-be-authenticated information and the transformation information.

Also in accordance with the disclosure, there is provided a control device including a processor configured to send transformation information to a third-party load, receive to-be-authenticated information sent by the third-party load and generated by the third-party load according to the transformation information and self-authentication information of the third-party load, and determine original authentication information of the third-party load according to the to-be-authenticated information and the transformation information.

### BRIEF DESCRIPTION OF THE DRAWINGS

In order to provide a clearer illustration of technical solutions of disclosed embodiments, the drawings used in the description of the disclosed embodiments are briefly described below. It will be appreciated that the disclosed drawings are merely examples and other drawings conceived by those having ordinary skills in the art on the basis of the described drawings without inventive efforts should fall within the scope of the present disclosure.

FIG. 1A is a schematic diagram of an application architecture of a control method consistent with embodiments of the disclosure.

FIG. 1B is a schematic diagram of another application architecture of a control method consistent with embodiments of the disclosure.

FIG. 2 is a schematic flow chart of a control method consistent with embodiments of the disclosure.

FIG. 3 is a schematic flow chart of another control method consistent with embodiments of the disclosure.

FIG. 4 is a schematic flow chart of another control method consistent with embodiments of the disclosure.

FIG. 5 is a schematic flow chart of another control method consistent with embodiments of the disclosure.

FIG. 6 is a schematic flow chart of another control method consistent with embodiments of the disclosure.

FIG. 7 is a schematic flow chart of another control method consistent with embodiments of the disclosure.

FIG. 8 is a schematic structural diagram of a control device consistent with embodiments of the disclosure.

FIG. 9 is a schematic structural diagram of a third-party load consistent with embodiments of the disclosure.

FIG. 10 is a schematic structural diagram of a first control device consistent with embodiments of the disclosure.

FIG. 11 is a schematic structural diagram of a second control device consistent with embodiments of the disclosure.

### DETAILED DESCRIPTION OF THE EMBODIMENTS

In order to provide a clearer illustration of technical solutions of disclosed embodiments, example embodiments will be described with reference to the accompanying drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

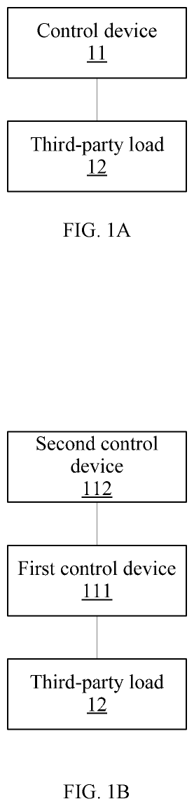

FIG. 1A is a schematic diagram of an example application architecture of a control method consistent with the disclosure. As shown in FIG. 1A, the application architecture of the method includes a control device 11 and a third-party load 12. The control device 11 can be communicatively coupled to the third-party load 12. The control device 11 may send transformation information to the third-party load 12. The transformation information can include non-fixed information. The non-fixed information can refer to information that can be changed randomly each time before being sent out. The third-party load 12 may generate to-be-authenticated information of the third-party load 12 according to the transformation information and self-authentication information of the third-party load 12 and send the to-be-authenticated information to the control device 11. The self-authentication information of the third-party load 12 can include authentication information generated by the third-party load itself. The control device 11 may determine original authentication information of the third-party load 13 according to the to-be-authenticated information and the transformation information. In some embodiments, the control device 11 may include a server, a flight platform, or an adapter ring mounted at the flight platform. The flight platform may include an unmanned aerial vehicle (UAV).

FIG. 1B is a schematic diagram of another example application architecture of the control method consistent with the disclosure. As shown in FIG. 1B, the application architecture of the method includes a first control device 111, a second control device 112, and the third-party load 12. The first control device 111 may be communicatively coupled to the third-party load 12 and the second control device 112. The first control device 111 may send the transformation information to the third-party load 12, and the third-party load 12 may generate the to-be-authenticated information of the third-party load 12 according to the transformation information and the self-authentication information of the third-party load 12, and send the to-be-authenticated information to the first control device 111. The first control device 111 may send the to-be-authenticated information of the third-party load 12 and the transformation information to the second control device 112. The second control device 112 may determine the original authentication information of the third-party load according to the to-be-authenticated information and the transformation information. In some embodiments, the first control device 111 may include a flight platform or an adapter ring mounted at the flight platform, and the second control device 112 may include a server.

The communication connection described above may include a direct communication connection or an indirect communication connection, which is not limited here. For example, the first control device 111 and the second control device 112 may be communicatively coupled to each other through a user device.

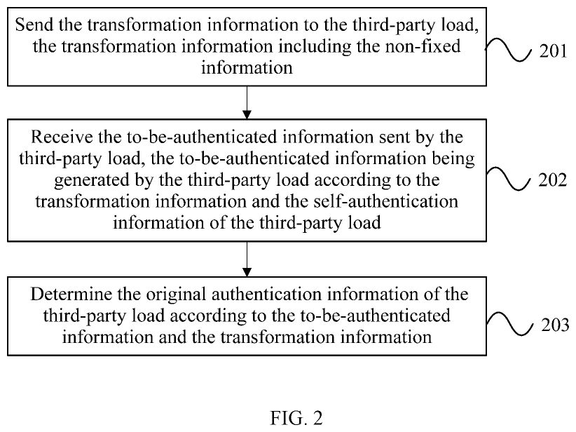

FIG. 2 is a schematic flow chart of an example control method consistent with the disclosure. The method may be executed by a control device, for example, the control device 11 in the architecture shown in FIG. 1A. As shown in FIG. 2, at 201, the transformation information is sent to the third-party load, the transformation information including the non-fixed information.

The transformation information may include transformation information corresponding to any transformation algorithm supporting a reversible transformation. The transformation algorithm supporting the reversible transformation may include, for example, an encryption algorithm, and the corresponding transformation information may include a secret key. The encryption algorithm may include, for example, the Message Digest Algorithm (MD5) algorithm, the Secure Hash Algorithm (SHA), or the like. In some embodiments, the transformation information may include information that changes according to a certain rule, or information that changes randomly (e.g., a random number), which is not limited here. For example, assume that there are 5 transformation information, namely transformation information 1 to transformation information 5. The control device can send 5 transform information to the third-party load in an order of transformation information 1, transformation information 2, transformation information 3, transformation information 4, and transformation information 5.

At 202, the to-be-authenticated information sent by the third-party load is received, the to-be-authenticated information being generated by the third-party load according to the transformation information and the self-authentication information of the third-party load.

The to-be-authenticated information sent by the third-party load can be used by the control device to authenticate the third-party load. The to-be-authenticated information can be generated by the third-party load according to the transformation information and the self-authentication information of the third-party load. For example, the to-be-authenticated information can be generated via transforming, by the third-party load, some pieces or all of the self-authentication information according to the transformation information. Therefore, a leakage of the to-be-authenticated information cannot cause a leakage of the self-authentication information of the third-party load. Moreover, the transformation information can include the non-fixed information, such that even if other people can learn the communication protocol of the third-party load and obtain the to-be-authenticated information of the third-party load based on the communication protocol, they cannot use the to-be-authenticated information of the third-party load for authentication, and hence a validity of the load carried on the flight platform is ensured.

A method for receiving the to-be-authenticated information sent by the third-party load is not limited here. For example, the to-be-authenticated information sent by the third-party load can be passively received, or the to-be-authenticated information sent by the third-party load can be actively requested through a query.

At 203, according to the to-be-authenticated information and the transformation information, the original authentication information of the third-party load is determined.

Because the to-be-authenticated information can be generated via transforming, by the third-party load, part or all of the self-authentication information according to the transformation information, the control device can determine the original authentication information of the third-party load based on the to-be-authenticated information and the transformation information. In some embodiments, determining the original authentication information of the third-party load according to the to-be-authenticated information and the transformation information may include, reversely transforming the to-be-authenticated information using the transformation information to obtain the original authentication information of the third-party load, or reversely transforming the to-be-authenticated information using information corresponding to the transformation information (e.g., in an asymmetric encryption, a secret key of one party can be understood as the transformation information and a secret key of the other party can be understood as the information corresponding to the transformation information) to obtain the original authentication information of the third-party load. Assume that an algorithm using which the control device determines the original authentication information of the third-party load based on the transformation information is Algorithm 1 and an algorithm using which the third-party load generates the to-be-authenticated information based on the transformation information is Algorithm 2, then Algorithm 1 and Algorithm 2 can be each other's reverse algorithms.

Consistent with the disclosure, the transformation information can be sent to the third-party load, and the to-be-authenticated information sent by the third-party load can be received. The to-be-authenticated information can be generated by the third-party load according to the transformation information and the self-authentication information of the third-party load. According to the to-be-authenticated information and the transformation information, the original authentication information of the third-party load can be determined, such that the self-authentication information is no longer transmitted between the third-party load and the control device. Therefore, even if other people can learn the communication protocol of the third-party load, they cannot obtain the self-authentication information of the third-party load based on the communication protocol, and hence the security of the self-authentication information of the third-party load is improved. Moreover, the transformation information can include the non-fixed information, such that even if other people can learn the communication protocol of the third-party load and obtain the to-be-authenticated information of the third-party load based on the communication protocol, they cannot use the to-be-authenticated information of the third-party load for authentication, and hence the validity of the load carried on the flight platform is ensured.

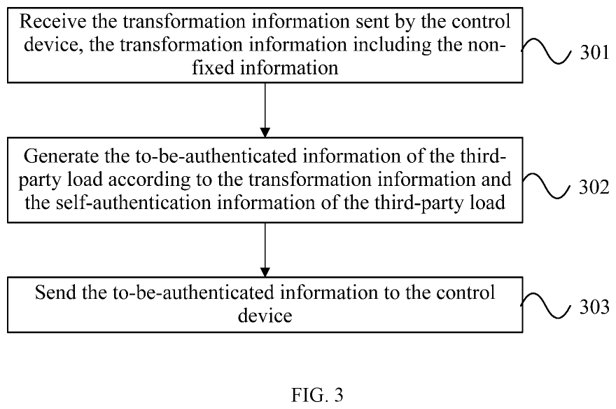

FIG. 3 is a schematic flow chart of another example control method consistent with the disclosure. The method may be executed by a third-party load, for example, the third-party load 12 in the architecture shown in FIGS. 1A and 1B. As shown in FIG. 3, at 301, the transformation information sent by the control device is received, the transformation information including the non-fixed information. The process at 301 is similar to the process at 201, and detailed description thereof is omitted here.

At 302, the to-be-authenticated information of the third-party load is generated according to the transformation information and the self-authentication information of the third-party load.

In some embodiments, the to-be-authenticated information can be generated via transforming, by the third-party load, some pieces or all of the self-authentication information according to the transformation information. Since the to-be-authenticated information of the third-party load is generated based on the transformation information and the self-authentication information of the third-party load, the leakage of the to-be-authenticated information cannot cause the leakage of the self-authentication information of the third-party load.

At 303, the to-be-authenticated information is sent to the control device.

A method for sending the to-be-authenticated information to the control device is not limited here. For example, the to-be-authenticated information can be actively sent to the control device, or the to-be-authenticated information can be passively sent to the control device when the control device queries.

For the architecture shown in FIG. 1A, the control device referred to above in the processes at 301 and 303 can be regarded as the control device 11 in FIG. 1A. For the architecture shown in FIG. 1B, the control device referred to above in the processes at 301 and 303 can be regarded as the first control device 111 in FIG. 1B.

Consistent with the disclosure, the transformation information sent by the control device can be received. The to-be-authenticated information can be generated according to the transformation information and the self-authentication information of the third-party load. The to-be-authenticated information can be sent to the control device, such that the self-authentication information is no longer transmitted between the third-party load and the control device. Therefore, even if other people can learn the communication protocol of the third-party load, they cannot obtain the self-authentication information of the third-party load based on the communication protocol, hence the security of the self-authentication information of the third-party load is improved. Moreover, the transformation information can include the non-fixed information, such that even if other people can learn the communication protocol of the third-party load and obtain the to-be-authenticated information of the third-party load based on the communication protocol, they cannot use the to-be-authenticated information of the third-party load for authentication, hence the validity of the load carried on the flight platform is ensured.

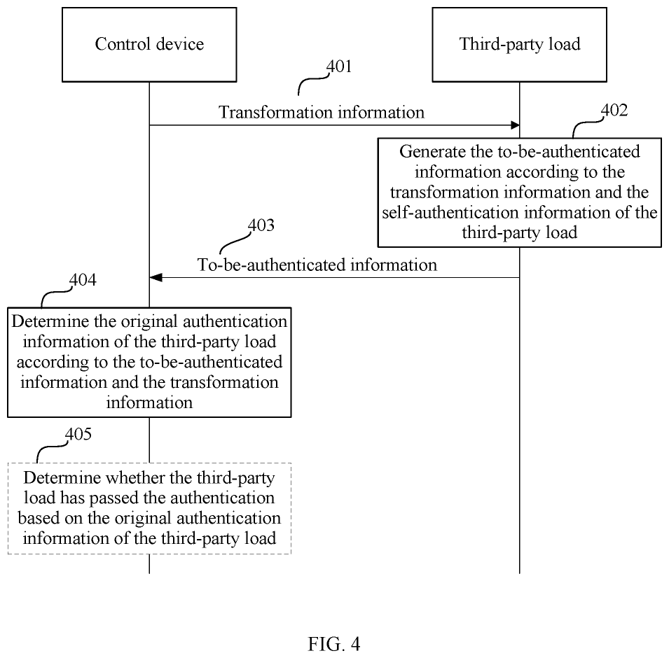

FIG. 4 is a schematic flow chart of another example control method consistent with the disclosure. The method mainly describes an interaction process between the control device and the third-party load on the basis of the methods in FIGS. 2 and 3 and the architecture in FIG. 1A.

As shown in FIG. 4, at 401, the control device sends the transformation information to the third-party load, the transformation information including the non-fixed information.

A condition for triggering the control device to send the transformation information to the third-party load is not limited here. For example, sending the transformation information can be triggered by a user, a timer, a message, and/or the like. In some embodiments, sending the transformation information to the third-party load can include: periodically sending the transformation information to the third-party load at a preset period, or, sending the transformation information to the third-party load according to a user input, or, sending the transformation information to the third-party load according to a trigger message from another device. For example, the transformation information can be sent to third-party load every 7 days. As another example, since it is generally needed to bind the third-party load to the flight platform or the adapter ring before the third-party load can communicate with the flight platform or the adapter ring, the transformation information may be sent to the third-party load when a notification message indicating that the user needs to set the binding is received, or the transformation information may be sent to the third-party load when an administrator inputs an instruction for setting the binding.

At 402, the third-party load generates the to-be-authenticated information according to the transformation information and the self-authentication information of the third-party load.

In some embodiments, according to the transformation information and the self-authentication information, a preset transformation algorithm is used to generate the to-be-authenticated information of the third-party load. In some embodiments, the preset transformation algorithm may include a preset encryption algorithm. In some embodiments, all of the self-authentication information of the third-party load can be transformed according to the transformation information to obtain the to-be-authenticated information of the third-party load, or some pieces of the self-authentication information of the third-party load can be transformed according to the transformation information and other pieces of the self-authentication information of the third-party load can be not transformed to obtain the to-be-authenticated information of the third-party load.

In some embodiments, the self-authentication information of the third-party load can be divided based on an importance of the information. Furthermore, some pieces of the self-authentication information can be selected for transformation according to a division result. In some embodiments, the self-authentication information of the third-party load may include key information and non-key information. The process at 401 can include transforming the key information in the self-authentication information of the third-party load, according to the transformation information and the preset transformation algorithm, to obtain temporary information in the to-be-authenticated information of the third-party load. The to-be-authenticated information can include the temporary information obtained by transforming the key information in the self-authentication information of the third-party load, thereby providing a security of the key information in the self-authentication information. In some embodiments, the to-be-authenticated information can further include the non-key information in the self-authentication information of the third-party load. In some embodiments, for the non-key information in the self-authentication information of the third-party load included in the to-be-authenticated information, the non-key information in the self-authentication information of the third-party load may be used as non-key information in the original authentication information of the third-party load.

The key information may include information having higher importance, and the non-key information may include information having lower importance. For example, the key information may include an authorization license of the third-party load, and the non-key information may include a user account and/or an identifier of the third-party load. The user account may include an account of an enterprise user of a payload SDK registered by user on a developer website (e.g., https://developer.dji.com). The identifier of the third-party load may include, for example, a name of the third-party load and/or a number of the third-party load.

At 403, the third-party load sends the to-be-authenticated information to the control device. The process at 403 is similar to the process at 303, and detailed description thereof is omitted here.

At 404, the control device determines the original authentication information of the third-party load according to the to-be-authenticated information and the transformation information.

In some embodiments, according to the transformation information and the self-authentication information, the preset transformation algorithm can be used to generate the to-be-authenticated information of the third-party load. In some embodiments, the preset transformation algorithm may include the preset encryption algorithm. In some embodiments, the to-be-authenticated information can include the temporary information generated by the third-party load transforming the key information in the self-authentication information of the third-party load according to the transformation information. The process at 404 can further include reversely transforming the temporary information in the to-be-authenticated information, according to the transformation information and the preset transformation algorithm, to obtain key information in the original authentication information of the third-party load. In some embodiments, the to-be-authenticated information can further include the non-key information in the self-authentication information of the third-party load. In some embodiments, the process at 404 can further include using the non-key information in the self-authentication information of the third-party load as the non-key information in the original authentication information of the third-party load.

In some embodiments, when the control device is a server, the method may further include the process at 405 after the process at 404. At 405, the control device determines whether the third-party load has passed the authentication based on the original authentication information of the third-party load.

In some embodiments, whether the third-party load has passed the authentication can be determined by determine whether the original authentication information of the third-party load is stored in a local storage space or an external storage space of the control device. In some embodiments, it can be determined that the third-party load has passed the authentication, in response to the original authentication information of the third-party load being stored, and it can be determined that the third-party load has not passed the authentication, in response to the original authentication information of the third-party load being not stored.

When the third-party load has passed the authentication, the third-party load can be bound to the flight platform or the adapter ring. In some embodiments, when it is determined that the third-party load has passed the authentication, a binding message may be sent to the flight platform or the adapter ring. The binding message can be used to instruct to bind the third-party load to the flight platform or the adapter ring. In some embodiments, after the flight platform (or adapter ring) receives the binding message, the flight platform (or adapter ring) may allow the third-party load to communicate with it.

Consistent with the disclosure, the control device can send the transformation information to the third-party load. The third-party load can generate the to-be-authenticated information according to the transformation information and the self-authentication information of the third-party load, such that the self-authentication information is no longer transmitted between the third-party load and the control device. Therefore, even if other people can learn the communication protocol of the third-party load, they cannot obtain the self-authentication information of the third-party load based on the communication protocol, and hence the security of the self-authentication information of the third-party load is improved. Moreover, the transformation information can include the non-fixed information, such that even if other people can learn the communication protocol of the third-party load and obtain the to-be-authenticated information of the third-party load based on the communication protocol, they cannot use the to-be-authenticated information of the third-party load for authentication, and hence the validity of the load carried on the flight platform is ensured.

In some embodiments, the third-party load may send the to-be-authenticated information to the server via a message, or may send the to-be-authenticated information to the server via multiple messages, which is not limited here.

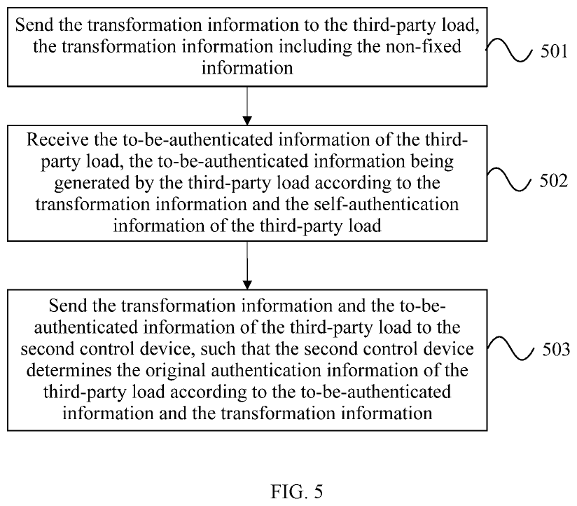

FIG. 5 is a schematic flow chart of another example control method consistent with the disclosure. The method may be executed by a first control device, for example, the first control device 111 in the architecture shown in FIG. 1B.

As shown in FIG. 5, at 501, the transformation information is sent to the third-party load, the transformation information including the non-fixed information. The process at 501 is similar to the process at 201 and 401, and detailed description thereof is omitted here.

At 502, the to-be-authenticated information of the third-party load is received, the to-be-authenticated information being generated by the third-party load according to the transformation information and the self-authentication information of the third-party load. The process at 502 is similar to the process at 202, and detailed description thereof is omitted here.

At 503, the transformation information and the to-be-authenticated information of the third-party load are sent to the second control device, such that the second control device determines the original authentication information of the third-party load according to the to-be-authenticated information and the transformation information.

The transformation information and the to-be-authentication information of the third-party load can be sent to the second control device, and the second control device can determine the original authentication information of the third-party load according to the to-be-authentication information and the transformation information. In some embodiments, in order to ensure a security of data transmission between the first control device and the second control device, data can be sent between the first control device and the second control device in an encrypted manner. For example, an encryption key (e.g., AuthKey) can be used to encrypt data using the Advanced Encryption Standard (AES) 128.

Consistent with the disclosure, the transformation information can be sent to the third-party load, and the to-be-authenticated information sent by the third-party load can be received. The to-be-authenticated information can be generated by the third-party load according to the transformation information and the self-authentication information of the third-party load. The to-be-authenticated information and the transformation information can be sent to the second control device, such that, according to the to-be-authenticated information and the transformation information, the second control device can determine the original authentication information of the third-party load. As such, the self-authentication information is no longer transmitted between the third-party load and the first control device. Therefore, even if other people can learn the communication protocol of the third-party load, they cannot obtain the self-authentication information of the third-party load based on the communication protocol, and hence the security of the self-authentication information of the third-party load is improved. Moreover, the transformation information can include the non-fixed information, such that even if other people can learn the communication protocol of the third-party load and obtain the to-be-authenticated information of the third-party load based on the communication protocol, they cannot use the to-be-authenticated information of the third-party load for authentication, and hence the validity of the load carried on the flight platform is ensured.

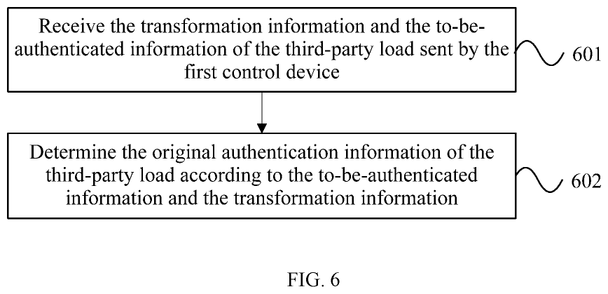

FIG. 6 is a schematic flow chart of another example control method consistent with the disclosure. The method may be executed by a second control device, for example, the second control device 112 in the architecture shown in FIG. 1B.

As shown in FIG. 6, at 601, the transformation information and the to-be-authenticated information of the third-party load sent by the first control device are received.

The transformation information can include the non-fixed information. The to-be-authenticated information of the third-party load can be generated by the third-party load according to the transformation information and the self-authentication information of the third-party load. For the relevant description of the transformation information and the to-be-authenticated information of the third-party load, reference may be made to the methods in FIGS. 2 to 5, and detailed description thereof is omitted here.

At 602, according to the to-be-authenticated information and the transformation information, the original authentication information of the third-party load is determined. The process at 602 is similar to the processes at 203 and 404, and detailed description thereof is omitted here.

Consistent with the disclosure, the transformation information and the to-be-authenticated information of the third-party load sent by the first control device can be received. According to the to-be-authenticated information and the transformation information, the original authentication information of the third-party load can be determined. The to-be-authenticated information can be generated by the third-party load according to the transformation information and the self-authentication information of the third-party load. As such, the self-authentication information is no longer transmitted between the third-party load and the first control device. Therefore, even if other people can learn the communication protocol of the third-party load, they cannot obtain the self-authentication information of the third-party load based on the communication protocol, and hence the security of the self-authentication information of the third-party load is improved. Moreover, the transformation information can include the non-fixed information, such that even if other people can learn the communication protocol of the third-party load and obtain the to-be-authenticated information of the third-party load based on the communication protocol, they cannot use the to-be-authenticated information of the third-party load for authentication, and hence the validity of the load carried on the flight platform is ensured.

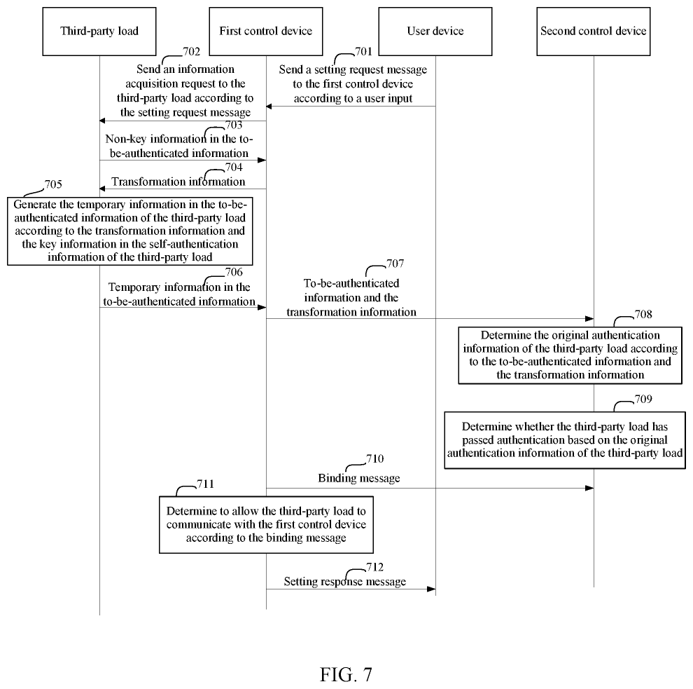

FIG. 7 is a schematic flow chart of another example control method consistent with the disclosure. The method mainly describes an interaction process among the first control device, the second control device, the third-party load, and the user device, on the basis of the methods in FIGS. 5 and 6 and the architecture in FIG. 1B.

As shown in FIG. 7, at S701, the user device sends a setting request message to the first control device according to a user input.

The setting request message may be used to request to set the first control device to bound to the third-party load and notify the first control device to obtain the to-be-authenticated information. In some embodiments, the user device may provide the user with an application program for managing the third-party load. The user may input a binding instruction for requesting binding of the third-party load based on the application program. The user device may send the setting request message to the first control device according to the binding instruction. In some embodiments, the setting request message may include the user account of the user.

At 702, the first control device sends an information acquisition request to the third-party load according to the setting request message. The information acquisition request can be used to request the non-key information in the self-authentical information of the third-party load.

At 703, the third-party load sends the non-key information in the to-be-authenticated information of the third-party load to the first control device according to the information acquisition request. The non-key information in the to-be-authenticated information of the third-party load can be the non-key information in the self-authentication information of the third-party load.

At 704, the first control device sends the transformation information to the third-party load, the transformation information including the non-fixed information. The process at 704 is similar to the processes at 201 and 401, and detailed description thereof is omitted here.

At 705, the third-party load generates the temporary information in the to-be-authenticated information of the third-party load according to the transformation information and the key information in the self-authentication information of the third-party load. For the methods of generating the temporary information in the to-be-authenticated information of the third-party load, reference may be made to the related description in the methods in FIGS. 5 and 6, and detailed description thereof is omitted here.

At 706, the third-party load sends the temporary information in the to-be-authenticated information to the first control device.

It should be appreciated that the processes at 701 to 706 are merely an example of the first control device sending the transformation information to the third-party load and receiving the to-be-authenticated information sent by the third-party load.

At 707, the first control device sends the to-be-authenticated information and the transformation information to the second control device. In some embodiments, the first control device may send the to-be-authenticated information and the transformation information to the user device, and the user device may forward the to-be-authenticated information and the transformation information to the second control device.

At 708, the second control device determines the original authentication information of the third-party load according to the to-be-authenticated information and the transformation information. The process at 708 is similar to the processes at 203 and 404, and detailed description thereof is omitted here.

At 709, the second control device determines whether the third-party load has passed authentication based on the original authentication information of the third-party load. When it is determined that the third-party load has not passed the authentication, the flow of the method may end. When it is determined that the third-party load has passed the authentication, the process at 710 may be implemented.

At 710, the second control device sends the binding message to the first control device, the binding message being used to indicate a binding of the third-party load. When the third-party load has passed the authentication, it indicates that the third-party load can communicate with the first control device. Therefore, when it is determined that the third-party load has passed the authentication, the binding message may also be sent to the first control device. In some embodiments, the binding message may include the original authentication information of the third-party load. In some embodiments, the binding message may further include a binding time, for example, Mar. 19, 2018, or 15:00 on Mar. 19, 2018. In some embodiments, the second control device may send the binding message to the user device, and the user device may forward the binding message to the first control device.

At 711, the first control device determines to allow the third-party load to communicate with the first control device according to the binding message. If the first control device allows the third-party load to communicate with the first control device, when the third-party load is carried on the flight platform, the user can control the third-party load according to requirements during the flight of the flight platform. If the first control device prohibits the third-party load from communicating with the first control device, when the third-party load is carried on the flight platform, the user cannot control the third-party load according to requirements during the flight of the flight platform.

In some embodiments, when the first control device receives the binding message, the process at 712 may be implemented. At 712, the first control device sends a setting response message to the user device, the setting response message being used to indicate that the binding is complete.

When the second control device determines whether the third-party load has passed the authentication, a communication connection needs to be established between the first control device and the second control device. In order to avoid the problem of poor user experience when the user frequently establishes the communication connection between the first control device and the second control device, the second control device may determine whether the third-party load has been authenticated only in the scenario corresponding to the process at 701. When the third-party load has passed the authentication, the third-party load may be considered as a valid third-party load by the first control device and the second control device. When the third-party load is powered on again, the second control device will not determine whether it has passed the authentication again, and the authentication of the third-party load can be determined as valid by default. However, there may be a case where the effective third-party load has been replaced with an invalid third-party load without being known by the first control device.

Therefore, in order to ensure the validity of the third-party load carried by the flight platform, the first control device may store the original authentication information of the third-party load included in the binding message locally, and the first control device may also periodically send the transformation information to the third-party load with a preset period. Before the process at 707, the method may further include the first control device determining whether the original authentication information of the third-party load is stored locally. If the original authentication information of the third-party load is not saved locally, sending the transformation information and the to-be-authenticated information of the third-party load to the second control device by the first control device can be performed. If the original authentication information of the third-party load is stored locally, the first control device can determine the original authentication information of the third-party load according to the to-be-authenticated information and the transformation information, and determine whether the third-party load has passed authentication based on the original authentication information of the third-party load. In some embodiments, the first control device may further perform the following processes: when the third-party load is determined to be passed the authentication, determining that the third-party load is allowed to communicate with the first control device, when the third-party load is determined to be not passed the authentication, determining that the third-party load is prohibited from communicating with the first control device.

Consistent with the disclosure, the first control device can send the transform information to the third-party load, receive the to-be-authenticated information sent by the third-party load, and send the to-be-authenticated information and the transformation information to the second control device. The second control device can determine the original authentication information of the third-party load according to the to-be-authenticated information and the transformation information, such that the self-authentication information is no longer transmitted between the third-party load and the first control device. Therefore, even if other people can learn the communication protocol of the third-party load, they cannot obtain the self-authentication information of the third-party load based on the communication protocol, and hence the security of the self-authentication information of the third-party load is improved. Moreover, the transformation information can include the non-fixed information, such that even if other people can learn the communication protocol of the third-party load and obtain the to-be-authenticated information of the third-party load based on the communication protocol, they cannot use the to-be-authenticated information of the third-party load for authentication, and hence the validity of the load carried on the flight platform is ensured.

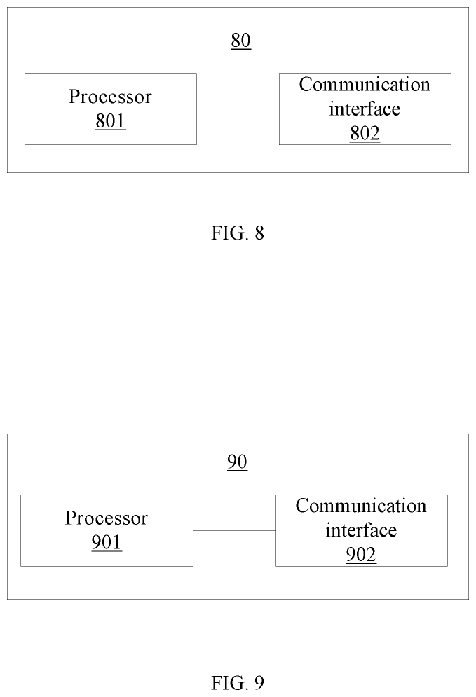

FIG. 8 is a schematic structural diagram of an example control device 80 consistent with the disclosure. As shown in FIG. 8, the control device 80 includes a processor 801. The processor 801 can be configured to send the transformation information to the third-party load, and the transformation information can include the non-fixed information. The processor 801 can be further configured to receive the to-be-authenticated information sent by the third-party load, and the to-be-authenticated information can be generated by the third-party load according to the transformation information and the self-authentication information of the third-party load. The processor 801 can be further configured to determine the original authentication information of the third-party load according to the to-be-authenticated information and the transformation information.

In some embodiments, the processor 801 sending the transformation information to the third-party load can include periodically sending the transformation information to the third-party load at the preset period, or, sending the transformation information to the third-party load according to the user input, or, sending the transformation information to the third-party load according to the trigger message from another device.

In some embodiments, the to-be-authenticated information can include the temporary information generated by the third-party load transforming the key information in the self-authentication information of the third-party load according to the transformation information.

The processor 801 determining the original authentication information of the third-party load according to the to-be-authenticated information and the transformation information can include reversely transforming the temporary information in the to-be-authenticated information, according to the transformation information and the preset transformation algorithm, to obtain the key information in the original authentication information of the third-party load.

In some embodiments, the preset transformation algorithm may include the preset encryption algorithm. In some embodiments, the key information in the self-authentication information of the third-party load may include the authorization license of the third-party load. In some embodiments, the to-be-authenticated information can further include the non-key information in the self-authentication information of the third-party load.

The processor 801 can be further configured to use the non-key information in the self-authentication information of the third-party load as the non-key information in the original authentication information of the third-party load.

In some embodiments, the control device 80 can include a server, a flight platform, or an adapter ring mounted at the flight platform.

In some embodiments, the processor 801 can be further configured to determine whether the third-party load has passed the authentication based on the original authentication information of the third-party load.

In some embodiments, the processor 801 can be further configured to send the binding message to the flight platform or the adapter ring after determining that the third-party load has passed the authentication. The binding message can be used to indicate the binding of the third-party load. In some embodiments, the transformation information can include the random number.

In some embodiments, the control device 80 further includes a communication interface 802. The processor 801 sending or receiving information or message can include the processor 801 sending or receiving the information or message through the control communication interface 802. For example, the processor 801 sending the transformation information to the third-party load can include the processor 801 controlling the communication interface 802 to send the transformation information to the third-party load. The processor 801 receiving the to-be-authenticated information sent by the third-party load can include the processor 801 controlling the communication interface 802 to receive the to-be-authenticated information sent by the third-party load.

The control device 80 may be used to execute the technical solutions of the control device in methods in FIGS. 2 and 4, and its implementation principles and technical effects are similar to those of the methods in FIGS. 2 and 4, and detailed description thereof is omitted here.

FIG. 9 is a schematic structural diagram of an example third-party load 90 consistent with the disclosure. As shown in FIG. 9, the third-party load 90 includes a processor 901. The processor 901 can be configured to receive the transformation information sent by the control device, and the transformation information can include the non-fixed information. The processor 901 can be further configured to generate the to-be-authenticated information of the third-party load according to the transformation information and the self-authentication information of the third-party load. The processor 901 can be further configured to send the to-be-authenticated information to the control device.

In some embodiments, the processor 901 generating the to-be-authenticated information of the third-party load according to the transformation information and the self-authentication information of the third-party load can include, generating the temporary information by transforming the key information in the self-authentication information of the third-party load according to the transformation information and the preset transformation algorithm.

In some embodiments, the preset transformation algorithm may include the preset encryption algorithm. In some embodiments, the key information may include the authorization license of the third-party load. In some embodiments, the to-be-authenticated information can further include the non-key information in the self-authentication information of the third-party load. In some embodiments, the transformation information can include the random number.

In some embodiments, the control device can include a server, a flight platform, or an adapter ring mounted at the flight platform.

In some embodiments, the third-party load 90 further includes a communication interface 902. In some embodiments, the processor 901 sending or receiving information or message can include the processor 901 sending or receiving the information or message through the control communication interface 902. For example, the processor 901 receiving the transformation information sent by the control device can include the processor 901 controlling the communication interface 902 to receive the transformation information sent by the control device. The processor 901 sending the to-be-authenticated information to the control device can include the processor 901 controlling the communication interface 902 to send the to-be-authenticated information to the control device.

The third-party load 90 may be used to execute the technical solutions of the third-party load 90 in methods in FIGS. 3 and 4, and its implementation principles and technical effects are similar to those of the methods in FIGS. 3 and 4, and detailed description thereof is omitted here.

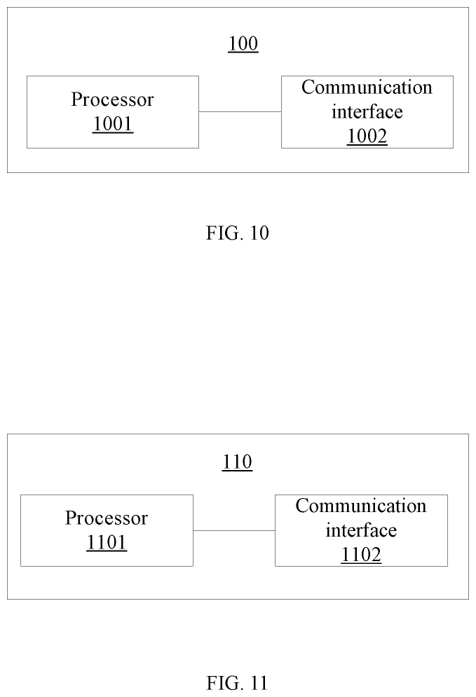

FIG. 10 is a schematic structural diagram of an example first control device 100 consistent with the disclosure. As shown in FIG. 10, the first control device 100 includes a processor 1001. The processor 1001 can be configured to send the transformation information to the third-party load, and the transformation information can include the non-fixed information.

The processor 1001 can be further configured to receive the to-be-authenticated information of the third-party load, and the to-be-authenticated information can be generated by the third-party load according to the transformation information and the self-authentication information of the third-party load. The processor 1001 can be further configured to send the transformation information and the to-be-authenticated information of the third-party load to the second control device, such that the second control device can determine the original authentication information of the third-party load according to the to-be-authenticated information and the transformation information.

In some embodiments, the processor 1001 sending the transformation information to the third-party load can include periodically sending the transformation information to the third-party load at the preset period, or, sending the transformation information to the third-party load according to the user input, or, sending the transformation information to the third-party load according to the trigger message from another device.

In some embodiments, the processor 1001 can be further configured to receive the binding message sent by the second control device. The binding message can be used to indicate the binding of the third-party load. The processor 1001 can be further configured to determine to allow the third-party load to communicate with the first control device according to the binding message.

In some embodiments, the binding message can include the original authentication information of the third-party load. The processor 1001 can be further configured to store the original authentication information of the third-party load locally.

In some embodiments, before sending the transformation information and the to-be-authenticated information of the third-party load to the second control device, the processor 1001 can be further configured to determine whether the original authentication information of the third-party load is stored locally, send the transformation information and the to-be-authenticated information of the third-party load to the second control device, in response the original authentication information of the third-party load being not saved locally, and determine the original authentication information of the third-party load according to the to-be-authenticated information and the transformation information and determine whether the third-party load has passed authentication based on the original authentication information of the third-party load, in response to the original authentication information of the third-party load being stored locally.

In some embodiments, the processor 1001 can be further configured to determine that the third-party load is allowed to communicate with the first control device, in response to determining that the third-party load has passed the authentication, and determine that the third-party load is prohibited from communicating with the first control device, in response to determining that the third-party load has not passed the authentication.

In some embodiments, the transformation information can include the random number. In some embodiments, the to-be-authenticated information of the third-party load can include the temporary information generated by the third-party load transforming the key information in the self-authentication information of the third-party load according to the transformation information.

In some embodiments, the key information in the self-authentication information of the third-party load may include the authorization license of the third-party load. In some embodiments, the to-be-authenticated information can further include the non-key information in the self-authentication information of the third-party load.

In some embodiments, the first control device 100 can include a flight platform or an adapter ring mounted at the flight platform.

In some embodiments, the first control device 100 further includes a communication interface 1002. The processor 1001 sending or receiving information or message can include the processor 1001 sending or receiving the information or message through the control communication interface 1002. For example, the processor 1001 sending the transformation information to the third-party load can include the processor 1001 controlling the communication interface 1002 to send the transformation information to the third-party load. The processor 1001 receiving the to-be-authenticated information of the third-party load can include the processor 1001 controlling the communication interface 1002 to receive the to-be-authenticated information of the third-party load. The processor 1001 sending the transformation information and the to-be-authenticated information of the third-party load to the second control device can include the processor 1001 controlling the communication interface 1002 to send the transformation information and the to-be-authenticated information of the third-party load to the second control device.

The first control device 100 may be used to execute the technical solutions of the first control device in methods in FIGS. 5 and 7, and its implementation principles and technical effects are similar to those of the methods in FIGS. 5 and 7, and detailed description thereof is omitted here.

FIG. 11 is a schematic structural diagram of an example second control device 110 consistent with the disclosure. As shown in FIG. 11, the second control device 110 includes a processor 1101. The processor 1101 can be configured to receive the transformation information and the to-be-authenticated information of the third-party load sent by the first control device. The transformation information can include the non-fixed information. The to-be-authenticated information of the third-party load can be generated by the third-party load according to the transformation information and the self-authentication information of the third-party load.

The processor 1101 can be further configured to determine the original authentication information of the third-party load according to the to-be-authenticated information and the transformation information. In some embodiments, the to-be-authenticated information can include the temporary information generated by the third-party load transforming the key information in the self-authentication information of the third-party load according to the transformation information.

The processor 1101 determining the original authentication information of the third-party load according to the to-be-authenticated information and the transformation information can include reversely transforming the temporary information in the to-be-authenticated information, according to the transformation information and the preset transformation algorithm, to obtain the key information in the original authentication information of the third-party load.

In some embodiments, the preset transformation algorithm may include the preset encryption algorithm. In some embodiments, the key information in the self-authentication information of the third-party load may include the authorization license of the third-party load. In some embodiments, the to-be-authenticated information can further include the non-key information in the self-authentication information of the third-party load.

The processor 1101 can be further configured to use the non-key information in the self-authentication information of the third-party load as the non-key information in the original authentication information of the third-party load.

In some embodiments, the processor 1101 can be further configured to determine whether the third-party load has passed the authentication based on the original authentication information of the third-party load.

In some embodiments, the processor 1101 can be further configured to send the binding message to the first control device after determining that the third-party load has passed the authentication. The binding message can be used to indicate the binding of the third-party load. In some embodiments, the binding message can include the original authentication information of the third-party load.

In some embodiments, the transformation information can include the random number. In some embodiments, the second control device can include a server.

In some embodiments, the second control device 110 further includes a communication interface 1102. The processor 1101 sending or receiving information or message can include the processor 1101 sending or receiving the information or message through the control communication interface 1102. For example, the processor 1101 receiving the transformation information and the to-be-authenticated information of the third-party load sent by the first control device can include the processor 1101 controlling the communication interface 1102 to receive the transformation information and the to-be-authenticated information of the third-party load sent by the first control device.

The second control device 110 may be used to execute the technical solutions of the second control device in methods in FIGS. 6 and 7, and its implementation principles and technical effects are similar to those of the methods in FIGS. 6 and 7, and detailed description thereof is omitted here.

The present disclosure further provides an example control system. The control system can include a control device (e.g., the control device 80 in FIG. 8) and a third-party load (e.g., the third-party load 90 in FIG. 9).

The present disclosure further provides another example control system. The control system can include a first control device (e.g., the first control device 100 in FIG. 10), a second control device (e.g., the second control device 110 in FIG. 11), and a third-party load (e.g., the third-party load 90 in FIG. 9).

Some or all of the processes of the method described above can be executed by hardware running program instructions. The program may be stored in a computer-readable storage medium. When the program is executed, the processes of the method are executed. The computer-readable storage medium can include a read-only memory (ROM), a random-access memory (RAM), a magnetic disk, an optical disk, or another medium that can store program codes.

It is intended that the disclosed embodiments be considered as exemplary only and not to limit the scope of the disclosure. Changes, modifications, alterations, and variations of the above-described embodiments may be made by those skilled in the art within the scope of the disclosure.

What is claimed is:

1. A control method comprising:
sending transformation information to a third-party load;
receiving to-be-authenticated information sent by the third-party load, the to-be-authenticated information being generated by the third-party load according to the transformation information and self-authentication information of the third-party load; and
determining original authentication information of the third-party load according to the to-be-authenticated information and the transformation information.

2. The method of claim 1, wherein sending the transformation information to the third-party load includes:
periodically sending the transformation information to the third-party load at a preset period;
sending the transformation information to the third-party load according to a user input; or
sending the transformation information to the third-party load according to a trigger message from another device.

3. The method of claim 1, wherein:
the to-be-authenticated information includes temporary information generated by the third-party load transforming key information in the self-authentication information of the third-party load according to the transformation information; and
determining the original authentication information of the third-party load includes:
reversely transforming the temporary information in the to-be-authenticated information, according to the transformation information and a preset transformation algorithm, to obtain key information in the original authentication information of the third-party load.

4. The method of claim 3, wherein the preset transformation algorithm includes a preset encryption algorithm.

5. The method of claim 3, wherein the key information in the self-authentication information of the third-party load includes an authorization license of the third-party load.

6. The method of claim 3, wherein:
the to-be-authenticated information includes non-key information in the self-authentication information of the third-party load; and
determining the original authentication information of the third-party load includes:
using the non-key information in the self-authentication information of the third-party load as non-key information in the original authentication information of the third-party load.

7. The method of claim 1, wherein the method is implemented by a control device including a server, a flight platform, or an adapter ring mounted at the flight platform.

8. The method of claim 7, wherein the control device includes the server and determining the original authentication information of the third-party load includes:
determining whether the third-party load has passed an authentication based on the original authentication information of the third-party load.

9. The method of claim 8, further comprising:
sending a binding message to the flight platform or the adapter ring after determining that the third-party load has passed the authentication, the binding message indicating a binding of the third-party load.

10. The method of claim 1, wherein the transformation information includes a random number.

11. A control device comprising:
a processor configured to:
send transformation information to a third-party load;
receive to-be-authenticated information sent by the third-party load, the to-be-authenticated information being generated by the third-party load according to the transformation information and self-authentication information of the third-party load; and
determine original authentication information of the third-party load according to the to-be-authenticated information and the transformation information.

12. The device of claim 11, wherein the processor is further configured to:
periodically send the transformation information to the third-party load at a preset period;
send the transformation information to the third-party load according to a user input; or
send the transformation information to the third-party load according to a trigger message from another device.

13. The device of claim 11, wherein:
the to-be-authenticated information includes temporary information generated by the third-party load transforming key information in the self-authentication information of the third-party load according to the transformation information; and
the processor is further configured to:
reversely transform the temporary information in the to-be-authenticated information, according to the transformation information and a preset transformation algorithm, to obtain key information in the original authentication information of the third-party load.

14. The device of claim 13, wherein the preset transformation algorithm includes a preset encryption algorithm.

15. The device of claim 13, wherein the key information in the self-authentication information of the third-party load includes an authorization license of the third-party load.

16. The device of claim 13, wherein:
the to-be-authenticated information further includes non-key information in the self-authentication information of the third-party load; and
the processor is further configured to:
use the non-key information in the self-authentication information of the third-party load as non-key information in the original authentication information of the third-party load.

17. The device of claim 11, wherein the control device includes a server, a flight platform, or an adapter ring mounted at the flight platform.

18. The device of claim 17, wherein the processor is further configured to:
determine whether the third-party load has passed an authentication based on the original authentication information of the third-party load.

19. The device of claim 18, wherein the processor is further configured to:
send a binding message to the flight platform or the adapter ring after determining that the third-party load has passed the authentication, the binding message indicating a binding of the third-party load.

20. The device of claim 11, wherein the transformation information includes a random number.
